(19) United States
(12) Patent Application Publication
(10) Pub. No.: US 2010/0159164 A1
(43) Pub. Date: Jun. 24, 2010

(54) INKJET PRINTING PAPER

(76) Inventors: Zhiyi Zhang, Naperville, IL (US); Angela P. Zagala, Cary, NC (US)

Correspondence Address: NALCO COMPANY, 1601 W. DIEHL ROAD, NAPERVILLE, IL, 60563-1198, US

(21) Appl. No.: 12/338,577

(22) Filed: Dec. 18, 2008

(51) Int. Cl. D21H 19/12; B05D 7/04; D21H 19/36; B32B 29/06

(52) U.S. Cl. 428/32.1; 428/32.38; 428/32.21; 428/32.29; 428/32.28; 427/369

(57) ABSTRACT

The invention provides an ink jet recording sheet which is highly resistant to printings smearing, running, feathering, color bleeding, or fading when wet, humid, or exposed to intense or continual light. The recording sheet has a solid substrate and a composition coating the solid substrate. The composition comprises a cationic polymer as well as starch, inorganic salt, pigment, and water. The composition can further comprise a non-ionic polymer. The coating tightly binds both pigment based inkjet inks and dye based inkjet inks. The composition is easy to apply and the ink jet recording sheet can be easily formed with a standard size press device.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to film forming polymer compositions and their use with sheets of inkjet printing paper. Inkjet printing is a non-impact digital printing technology. Unlike laser, dry toner, offset, and other forms of contact printing, non-impact printing uses liquid ink. There are two primary types of inkjet printing technology, continuous and drop-on-demand. Both types of inkjet printing involve a pool of liquid ink that is broken up into individual droplets by high frequency vibration when it leaves the nozzle. This technology enables inkjet printing to achieve higher printing speeds than toner printing.

Drop-on-demand inkjet printing devices generate ink droplets when needed using a thermal (bubble) mechanism or piezoelectric technique. Continuous ink jet printers utilize electrostatic charging devices to continuously supply an ink stream at high velocity to the nozzles during printing. These electrostatic charging devices break the ink fluid into individual ink droplets, which are directed towards the paper substrate or towards an ink-capturing device. Both drop-on-demand and continuous inkjet printing technologies have broad applications such as printing devices for home and office, bar code applications, and industrial printing uses.

The liquid ink of inkjet devices has three basic components: a solvent, a colorant, and a humectant. The humectant is a nonvolatile cosolvent (such as glycerin or ethylene glycol), which absorbs water from the air and keeps the nozzle moist and clog free. The colorant is either a dye or a pigment. Dyes are soluble in the solvent, have a uniform homogenous phase, and easily pass through the nozzle. Pigments are non-soluble particles, must be adequately dispersed by the solvent, and can dry out and form aggregates which clog inkjet nozzles. Water is a common solvent because it has a low viscosity, high surface tension, dissolves dyes, and is a good dispersion medium for pigments. Aqueous inkjet inks therefore are more environmentally friendly, less toxic, and are non-combustible.

Unfortunately, printing with aqueous inkjet inks and especially dye-based inks have some disadvantages. Aqueous inkjet inks adhere less strongly to paper substrates and as a result they are more sensitive to surface friction forces, react with light and detach from the paper substrate, and are prone to feathering. In addition because they are water soluble, dye-based aqueous inkjet inks also diffuse in humidity when wetted. As a result, when these inks are printed on high stress surfaces that undergo numerous environmental changes the printing may get smeared. Some examples of these sorts of high stress surfaces are promotion documents, transaction bills, and addresses on envelopes. One attempt at addressing this disadvantage is described in U.S. Pat. No. 6,824,840 which describes a hydrophobic cationic dispersion polymer layer applied to the surface of the printer paper which enhances print density, detail, color depth and vibrancy, and drying. Another attempt is described in U.S. Pat. No. 6,764,726.

A need remains however for inkjet receiving sheets suitable for use with aqueous-based inks. There is a need for inkjet receiving sheets to have improved image stability with good ink adhesion during wet rubbing. Further, there is a need for receiver sheets that enable prints with improved optical density. In addition, there is also a need for receiver sheets with high degree of waterfastness. The need also exists for inkjet receiving sheets with good bleed resistance. Finally, there is a need for inkjet receiving sheets with good sheet property such as feel and touch before and after printing.

### BRIEF SUMMARY OF THE INVENTION

At least one embodiment of the invention is directed towards an ink jet recording sheet having a solid substrate and a composition coating the solid substrate. The composition comprises at least one cationic polymer. The composition can also comprise a second non-ionic polymer. The composition also comprises one item selected from the list consisting of starch, inorganic salt, pigment, water, and any combination thereof, or all of the items from the list. The substrate can be selected from the list consisting of cellulose, furnish, wet web, web paper, paper, or sheets of paper. These substrates can be treated, untreated, wood free, and wood containing substrates. The composition can be applied to the substrate when it is being smoothed out by a size press machine, a calendaring machine, a coating machine, a dryer section, or by any other machine commonly used in the papermaking process.

At least one embodiment of the invention is directed to an ink jet recording sheet in which at least one of the polymers has a reduced specific viscosity which is no greater than 30 dL/g and/or in which the non-ionic polymer is a polyvinyl alcohol with a hydrolysis level above 85%. The cationic polymer and the non-ionic polymer can together comprise between 2% and 35% by mass of the composition coating. The molar ratio of cationic polymer to non-ionic polymer can be 1:1. At least one of the polymers can be a copolymer. The cationic polymer can be an acrylamide-dimethylaminoethylacrylate benzyl chloride quaternary salt dispersion polymer/acrylamide copolymer. The non-ionic polymer can be a pigment dispersion polymer.

At least one embodiment of the invention is directed to an ink jet recording sheet in which the starch is one item selected from the list consisting of an ethylated starch and a cationic starch. The inorganic salt can be water-soluble and can have a charge that is at least a divalent charge, such as magnesium sulfate and calcium chloride. The pigment can be one item selected from the list consisting of: titanium oxide, aluminum oxide, clay, silica, and calcium carbonate. The recording sheet can be stored in a humidity and temperature controlled room for at least 12 hours before printing.

At least one embodiment of the invention is directed to an ink jet recording sheet having a coating composition in which the mass of the coating composition is 1-3% non-ionic polymer, 1-2% cationic polymer, 3-5% starch, 0.5-2% pigment, 0.5-2% salt, and 80% to 94% water. At least one embodiment of the invention is directed to an ink jet recording sheet in which the mass of the coating composition is 1.8% cationic polymer, 1.5% polyvinyl alcohol polymer, 3.9% cationic starch, 0.8% calcium chloride, and 92% water.

At least one embodiment of the invention is directed to a method of increasing the inkjet ink adhesive properties of paper including the steps of: providing a solid substrate for making paper, providing a coating composition, and coating the solid substrate with the coating composition with a papermaking device. The coating composition comprises at least one cationic polymer, at least one non-ionic polymer, and one item selected from the list consisting of starch, inorganic salt, pigment, water, and any combination thereof.

A least one embodiment further comprises the step of preparing the coating composition. The preparation includes the steps of: providing at least one cationic polymer, providing at least one non-ionic polymer, providing at least one item selected from the list consisting of starch, inorganic salt, pigment, water, and any combination thereof, combining the at least one cationic polymer, the at least one non-ionic polymer, and the one item selected from the list consisting of starch, inorganic salt, pigment, water, and any combination thereof, and adding the non-ionic polymer after adding the cationic polymer.

### BRIEF DESCRIPTION OF THE DRAWINGS

FIG. 1 is an illustration of a papermaking process during which a substrate is treated with the composition.

FIG. 2A is an illustration of a water removal section of FIG. 1.

FIG. 2B is an illustration of a size press section and dryer section of FIG. 1.

FIG. 2C is an illustration of a water removal section of FIG. 1.

### DETAILED DESCRIPTION OF THE INVENTION

For purposes of this application the definition of these terms is as follows:

“Substrate” means a sheet of paper or a sheet of paper precursor that can be or has been treated by the inventive composition.

“Pulp” means the fibrous raw materials used to make paper, the fibrous raw materials are usually of vegetable origin, are commonly cellulose fibers, are commonly wood based, but may be synthetic or of other origin, and may contain pieces of wood.

“Furnish” means a sheet of paper precursor that comprises pulp and water and is approximately 5% or less solid matter.

“Wet Web” means a sheet of paper precursor that results from the processing of Furnish through a Water Removal Section.

“Web Paper” means a sheet of paper precursor that results from processing Wet Web by at least one Dryer Section.

“Paper” means a sheet of paper precursor that results from processing Web Paper by a Calendaring Section.

“Sheet of Paper” means Paper that has been cut into one or more useful shapes and/or sizes.

“Printer Paper” and “Inkjet Recording Sheet” means Paper or a Sheet of Paper suitable for use with a printer.

“Colorant” means a composition of matter that is deposited on a sheet of paper, adheres to the sheet of paper, and in most cases is a visibly different color than the sheet of paper.

As used in this definition, “color” includes the full chromatic spectrum as well as black, white, and every shade of grey. Colorants can be dyes and pigments.

“Dispersion” means a plurality of particles dispersed in a liquid medium to facilitate its transfer.

“Solvent” means a liquid medium used to facilitate transfer of particles, the particles may or may not be dissolved in the liquid medium.

“Water Fastness” means a measurement of how well printed ink remains attached to a sheet of paper when subjected to water.

“Light Fastness” means a measurement of how well printed ink remains attached to a sheet of paper when subjected to light.

“Feathering” is the tendency of printed ink to spread along the pores, fibrous channels, and irregularities on a paper substrate instead of adhering to the point of impact where a printer deposited it.

“Bleeding” is the tendency of printed ink to change color as a result of a first mass of printed ink feathering into a second mass of printed ink of another color.

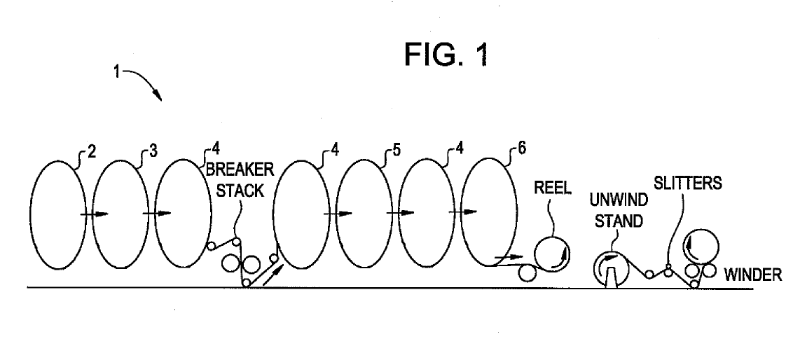

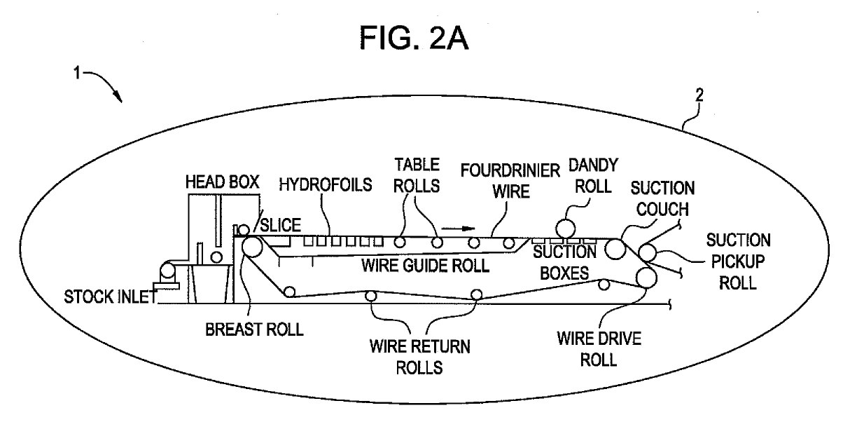

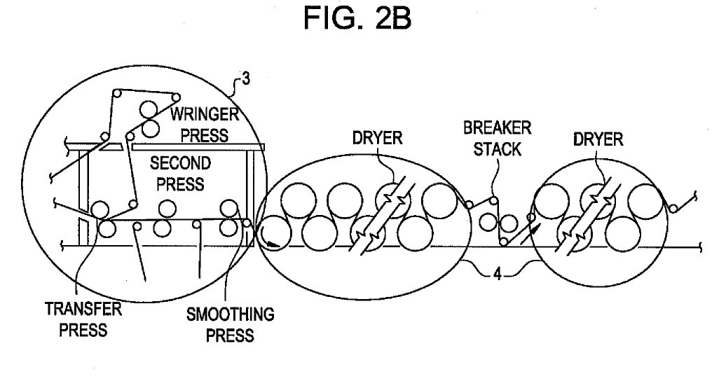

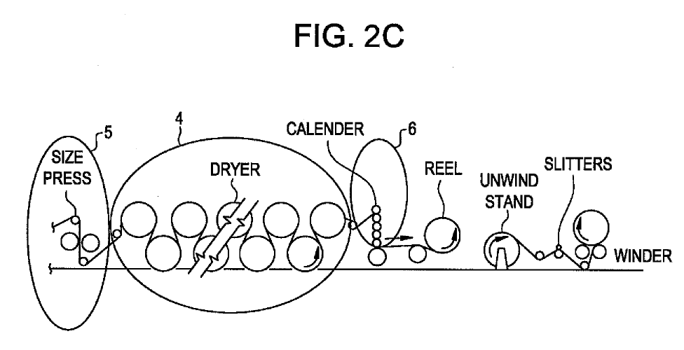

Referring now to FIGS. 1, 2A, 2B, and 2C there is shown at least one mechanism for the process of papermaking. The papermaking process (1) involves the processing of paper raw materials by a Water Removal Section (2), a Coating/Press Section (3), at least one Dryer Section (4), a Size Press Section (5), and a Calendar Section (6). A person of ordinary skill in the art will recognize that these various sections can be arranged in different orders, in greater or lesser numbers, and in combination with additional components or sections than those presented in these FIGs. A substrate of sheet of paper precursors in the papermaking process can be treated by a film forming polymer composition in the: Coating/Press Section (3), Size Press Section (5), Calendar Section (6), and/or during an additional or subsequent coating process.

In at least one embodiment of the invention a film forming polymer composition containing cationic polymers and other components together improve the properties of inkjet printer paper. In at least one embodiment the film forming polymer composition also comprises at least one non-ionic polymer. In at least one embodiment the film forming polymer composition is comprised of at least one cationic polymer and one or more components such as starch, polyvinyl alcohol, inorganic salt, pigments and water. The film forming polymer composition improves ink adhesion both for dye based and pigment based inkjet inks.

In the case of dye based inkjet inks, the anionic dyes bind tightly to the cationic polymers of the composition. In the case of pigment based inkjet inks, the cationic polymers of the composition bind the negatively charged portions of the pigment and the non-ionic polymer portions of the composition bind other portions of the pigment molecules. As a result, the composition more tightly binds inkjet inks and provides printed on sheets of paper greater light fastness, greater water fastness, and more resistance to rubbing out when wet, fading when wet, bleeding, and feathering. This improves overall paper handling.

In at least one embodiment of the invention the substrate for this invention is untreated wet web, web paper, paper, or a sheet of paper. The film forming polymer composition can be applied on a size press machine, a calendaring machine, and/or a paper coater as a surface treatment on the paper substrate (for example untreated wood-free substrate). Examples of papermaking machines are described in U.S. Pat. Nos. 4,565,155 and 4,413,586. The film forming polymer composition can be applied on the substrate by a wire-wound rod coater or by any other manner known in the art.

The film forming polymer composition can be prepared by cooking an aqueous starch solution using a steam cooker at 10 to 15% wt concentration, then adding the cationic polymer to the starch solution with mixing, then adding polyvinyl alcohol solution to the mixture with mixing, then adding the salt solution, then finally adding a pigment to the film forming polymer composition. The pigment may be added to the film forming polymer composition as a dispersion or in powder form. Water can be added before or after the cationic polymer addition to adjust to the desired % solids.

The cationic polymers of this invention with an RSV (Reduced Specific Viscosity) of 0.1 to 30 dL/g can be prepared by solution, gel, dry, dispersion, suspension and emulsion polymerization. In at least one embodiment the polymer is a cationic dispersion polymer with RSV of less than 10 due ease of transfer through pipes or pumps and mixing. Film forming polymer compositions can readily be made using low RSV cationic dispersion polymer due to ease of mixing. The cationic dispersion polymers of this invention have from 20 to 80 mole percent of cationic monomer.

The non-ionic polymer with RSV 0.1 to 30 dL/g can be prepared by solution, gel, dry, dispersion, suspension and emulsion polymerization. In at least one embodiment the polymer of this film forming polymer composition is polyvinyl alcohol with hydrolysis levels above 85%. A polyvinyl alcohol used in an example film forming polymer composition has a hydrolysis level of 99%.

In at least one embodiment the starches of this invention are those typically used in papermaking machines such as cationic modified and/or ethylated starch. Examples of the starches are Penford Gum 280 (an ethylated starch, by Penford Corp. of Centennial, Colo.) and Cerestar HS05972.

In at least one embodiment inorganic water-soluble salts with cations having divalent or higher charges are selected for use in the film forming polymer composition.

In at least one embodiment a component in the film forming composition includes a pigment. One of the selected pigments is calcium carbonate. A dispersion of calcium carbonate is preferred for ease of mixing into the film forming composition.

In at least one embodiment, after the substrate has been treated with the film forming composition, it is dried by passing the substrate through a dryer or other drying type equipment. The drying process facilitates smoothing out of the treated substrate. In at least one embodiment, the treated substrate is stored in a humidity and temperature controlled room for at least 12 hours before being printing on. Tests run on a Versamark continuous inkjet printing device (by Kodak Corp. of Rochester, N.Y.) have confirmed this.

The foregoing may be better understood by reference to the following examples, which are presented for purposes of illustration and are not intended to limit the scope of the invention.

### EXAMPLE 1

### Preparation of Cationic Dispersion Polymer

A 27% polymer solids, 50150 mole percent acrylamide/dimethylaminoethylacrylate benzyl chloride quaternary salt dispersion copolymer was prepared as follows:

A low viscosity model 1.5 liter reaction flask was fitted with a mechanical stirrer, baffle, thermocouple, condenser, nitrogen purge tube, an addition port and heating tape. To a 2 liter beaker were added 311.58 g de-ionized water, 23.08 g polyDADMAC (15% aqueous solution, Nalco), 58.46 g of polydimethylaminoethylacrylate methyl chloride quaternary salt (15% aqueous solution, Nalco), 153.85 g of ammonium sulfate, 19.23 g sodium sulfate, 9.23 g glycerin, 11.54 g adipic acid, 2.31 g sodium hypophosphite, 114.276 g of acrylamide (49.39% aqueous solution), 0.31 g of ethylenediaminetetraacetic acid, tetra sodium salt, and 281.92 g of dimethylaminoethylacrylate benzyl chloride quaternary salt (75.76% aqueous solution). The mixture was added to the reaction flask and heated to 48° C. while stirring at 700 rpm. After reaching 48° C., 1.15 g of a 1.0% aqueous solution of 2,2′-azobis(2-amidinopropane) dihydrochloride (Wako V-50, Wako Chemicals, Dallas, Tex.) was added to the reaction mixture and a constant purge of nitrogen was started. After one hour, 2.31 g of a 1% aqueous solution of 2,2′-azobis(2-amidinopropane) dihydrochloride was added. After an additional four hours, 3.08 g of a 10.0% aqueous solution of 2,2′-azobis[2-(2-imidazolin-2-yl)propane] dihydrochloride (VA-044, Wako Chemicals, Dallas, Tex.) was added. After two hours the reaction is cooled, and 7.69 g acetic acid was added.

The final product was a smooth, milky, white dispersion with a bulk viscosity of 200 to 800 cps and a reduced specific viscosity of 0.2-0.9 dl/g, measured for a 0.045% solution of the polymer in 0.125N aqueous sodium nitrate at 30° C.

### Preparation of Film Forming Composition

The lab scale coating formulations were prepared as follows:

The starch was placed into a steam cooker and cooked. Water was added to the starch mixture based on the formulation calculation to have solids % suitable for coating or size press applications. Then the cationic dispersion polymer was added to the batch with mixing. Polyvinyl alcohol solution was then added to the batch under mixing to prevent precipitation. Pre-made salt solution was added under mixing. Calcium carbonate dispersion was then added under mixing.

Film forming composition application:

The coating was applied onto the substrate, which was a wood free paper with size of about 8.5″ by 12″ and basis weight of about 90 gsm. The substrate sheet was fixed on the surface of a drawdown glass plate. And the coating liquid was applied onto paper substrate with a #9 drawdown rod. The treated substrate was then dried by passing through a drum dryer at 170 to 210 degree F. with the treated side facing the stainless steel drum surface. The other side was then treated and dried again in order to minimize paper curling for printing.

### FORMULATION EXAMPLES

TABLE 1
Representative Film forming Formulations

| | Example 1 | Example 2 | Example 3 |
|---|---|---|---|
| Cationic dispersion | 1.8 | 2.5 | 2.8 |
| polymer | | | |
| Cationic Starch | 3.9 | 4.2 | 3.5 |
| Polyvinyl alcohol | 1.5 | 1.7 | 1.2 |
| Calcium Chloride | 0.8 | 0 | 0 |
| Magnesium Sulfate | 0 | 0.6 | 0 |
| Calcium carbonate | 0 | 0 | 1.5 |
| Water | 92 | 91 | 91 |

The cationic dispersion polymer used in the example formulas was a 50/50 mole % acrylamide-co-DMAEA.BCQ copolymer with RSV equal to 0.5 synthesized by Nalco Company.

The cationic starch was CereStar HS05972 from Cerestar, Netherlands. Polyvinyl alcohol was from Celanese with trade name Celvol 125 or the solution form Celvol 08125.

Calcium chloride was purchased from VWR.

Magnesium sulfate was purchased from VWR.

Calcium carbonate was a dispersion product with the trade name JetSet from J. M. Huber at Atlanta, Ga.

The print quality being evaluated included ink density, water fastness, bleed % and ink wet rub %. Water fastness was expressed as the percentage of color density change for the printed ink at the maximum inking level. The ink density is a measurement of the degree of light reflection from the surface area of interest. The higher the ink density, the better the print image. For example, Kodak Versamark continuous inkjet printing desires waterfastness equal or higher than 99%.

The bleed % is the indication of print ink migrating into neighboring areas when the print target is soaked in water. Therefore, the quantitative expression of bleed % is the subtraction of ink density near soaked area from the optical density of paper substrate divided by the ink density before soaking×100. The desired bleed % by Kodak Versamark is less than 10% Wet ink adhesion or wet rub test determines how well the ink sustains the rub friction under wet conditions. The wet ink adhesion test was conducted by adding three drops of D.I. water onto the printed solid ink area thereafter, a 100 gram weight was placed on the water, then the ink area was rubbed toward the unprinted paper surface 10 times (back and forth). The wet rub % is expressed as {[(the ink density of the rubbed area near the print target)−(ink density of paper)]/Ink density of the print target before wet rub test}×100. The desired ink wet adhesion % by Kodak Versamark is less than 10%.

### PRINTING EXAMPLES

The printing test was done on HP DeskJet 6122 inkjet printer using Process Black from Collins Ink.

TABLE 2
Inkjet Print Data for Printed Sheets

| | | Waterfastness | | |
|---|---|---|---|---|
| Sheet example | Ink Density | % | Bleed % | Wet Rub % |
| Example 1 | 1.13 | 109 | 0 | 0.9 |
| Example 2 | 1.13 | 110 | 0.9 | 0.9 |
| Example 3* | 1.09 | 109 | 0.9 | 1.8 |
| Reference 1 | 1.11 | 114 | 3 | 35 |
| Reference 2 | 1.10 | 105 | 13 | 52 |
| Reference 3* | 1.07 | 104 | 0.0 | 0.9 |

Reference 1 was the commercial inkjet paper ImageGrip manufactured by International Paper.
Reference 2 was the commercial inkjet paper HP Advanced made by Hewlett Packard.
Reference 3 was the commercial inkjet paper Z Plot 650 manufactured by Ziegler.
*indicates that the printer paper was printed with ink lot number FY2003 manufactured by Collins Ink. The other examples were printed with ink lot number FV2003 manufactured by Collins Ink.

The data shown in Table 2 demonstrate that good print quality can be obtained using paper treated with the representative film forming formulations described in this invention.

Changes can be made in the composition, operation, and arrangement of the method of the invention described herein without departing from the concept and scope of the invention as defined in the claims. While this invention may be embodied in many different forms, there are shown in the drawings and described in detail herein specific preferred embodiments of the invention. The present disclosure is an exemplification of the principles of the invention and is not intended to limit the invention to the particular embodiments illustrated. Furthermore, the invention encompasses any possible combination of some or all of the various embodiments described herein. All patents, patent applications, and other cited materials mentioned anywhere in this application are hereby incorporated by reference in their entirety.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

This completes the description of the preferred and alternate embodiments of the invention. Those skilled in the art may recognize other equivalents to the specific embodiment described herein which equivalents are intended to be encompassed by the claims attached hereto.

1. An inkjet recording sheet having a substrate with at least one surface and a composition engaged to at least a portion of the at least one surface, the composition comprising at least one cationic polymer and one item selected from the list consisting of starch, inorganic salt, pigment, water, and any combination thereof.

2. The ink jet recording sheet of claim 1 in which the composition completely coats every surface of the substrate.

3. The ink jet recording sheet of claim 1 in which the composition further comprises at least one non-ionic polymer.

4. The ink jet recording sheet of claim 1 in which the substrate is selected from the list consisting of: cellulose, furnish, wet web, web paper, paper, sheet of paper, wood free sheet of paper precursor, wood bearing sheet of paper precursor, treated sheet of paper precursor, untreated sheet of paper precursor, wood free sheet of paper, wood bearing sheet of paper, treated sheet of paper, and untreated sheet of paper.

5. The ink jet recording sheet of claim 1 in which substrate has been smoothed out by a papermaking machine to reduce the presence of roughness or pores in at least a portion of the surface of the substrate and the composition has been applied to the roughness and pore reduced substrate surface by the papermaking machine.

6. The ink jet recording sheet of claim 1 in which at least one of the polymers has a reduced specific viscosity which is no greater than 30 dL/g.

7. The ink jet recording sheet of claim 3 in which the non-ionic polymer is a polyvinyl alcohol with a hydrolysis level above 85%.

8. The ink jet recording sheet of claim 1 in which the composition contains starch and the starch is one item selected from the list consisting of: an ethylated starch and a cationic starch.

9. The ink jet recording sheet of claim 1 in which the in which the composition contains an inorganic salt and the inorganic salt is water-soluble and has a charge that is at least a divalent charge.

10. The ink jet recording sheet of claim 1 in which the pigment is one item selected from the list consisting of: titanium oxide, aluminum oxide, clay, silica, and calcium carbonate.

11. The ink jet recording sheet of claim 3 in which the cationic polymer and the non-ionic polymer together comprise between 2% and 35% by mass of the composition coating.

12. The ink jet recording sheet of claim 3 in which molar ratio of cationic polymer to non-ionic polymer is 1:1.

13. The ink jet recording sheet of claim 3 in which at least one of the at least two polymers is a copolymer.

14. The ink jet recording sheet of claim 3 in which the cationic polymer is an acrylamide-dimethylaminoethylacrylate benzyl chloride quaternary salt dispersion polymer-acrylamide copolymer.

15. The ink jet recording sheet of claim 3 in which the non-ionic polymer is a pigment dispersion polymer.

16. The ink jet recording sheet of claim 3 in which the mass of the coating composition is 1-3% non-ionic polymer, 1-2% cationic polymer, 3-5% starch, 0.5-2% pigment, 0.5-2% salt, and 80% to 94% water.

17. The ink jet recording sheet of claim 3 in which the mass of the coating composition is 1.8% cationic polymer, 1.5% polyvinyl alcohol polymer, 3.9% cationic starch, 0.8% calcium chloride, and 92% water.

18. A method of increasing the inkjet ink adhesive properties of paper including the steps of:
providing a solid substrate for making paper,
providing a coating composition, the coating composition comprising at least one cationic polymer, at least one non-ionic polymer, and one item selected from the list consisting of starch, inorganic salt, pigment, water, and any combination thereof, and
coating the solid substrate with the coating composition with a size press device.

19. The method of claim 19 further comprising the step of synthesizing the coating composition, the synthesizing including the steps of:
providing at least one cationic polymer,
providing at least one non-ionic polymer,
providing at least one item selected from the list consisting of starch, inorganic salt, pigment, water, and any combination thereof,
combining the at least one cationic polymer, the at least one non-ionic polymer, and the one item selected from the list consisting of starch, inorganic salt, pigment, water, and any combination thereof, and
charging the non-ionic polymer after charging the cationic polymer.
